(19) United States
(12) Patent Application Publication
(10) Pub. No.: US 2022/0072831 A1
(43) Pub. Date: Mar. 10, 2022

(54) CAR GLASS PROTECTION FILM HAVING SELF-RESTORATION PERFORMANCE

(71) Applicant: STEK CO., LTD., Seoul (KR)

(72) Inventors: Changsuk LEE, Seoul (KR); Giyoon CHEON, Goyang-si (KR); Jinmyung KIM, Yeongdeok-gun (KR); Junga PARK, Daejeon (KR)

(21) Appl. No.: 17/416,496

(22) PCT Filed: Dec. 4, 2019
(86) PCT No.: PCT/KR2019/017009

§ 371 Date: Jun. 20, 2021

(30) Foreign Application Priority Data
Dec. 24, 2018 (KR) 10-2018-0168547

(51) Int. Cl. B32B 27/08; B32B 7/12; B32B 27/32; B32B 27/36; B32B 27/16; B60J 1/00; C09J 7/38; C09J 7/29

(52) U.S. Cl. CPC B32B 27/08; C09J 2203/354; B32B 27/32; B32B 27/36; B32B 27/16; B60J 1/001; C09J 7/385; C09J 7/29; B32B 2255/26; B32B 2255/28; B32B 2255/10; B32B 2307/732; B32B 2307/762; B32B 2571/00; B32B 2605/08; B32B 2405/00; C09J 2301/414; C09J 2301/162; B32B 7/12

(57) ABSTRACT

The disclosure relates to a car glass protection film having a self-restoration performance. More specifically, the film comprises: a substrate layer; a urethane coating layer formed on one surface of the substrate layer; a self-restoration layer formed on the upper surface of the urethane coating layer; a protection film layer formed on the upper surface of the self-restoration layer; and an adhesion layer formed on the other surface of the substrate layer. A car glass protection film having the structure described above does not show a separation phenomenon, which may be caused by temperature change, ultraviolet light, and external impact, exhibits excellent impact resistance by the urethane coating layer, and can recover from fine scratches by the self-restoration layer.

### TECHNICAL FIELD

The present disclosure relates to a car glass protection film having a self-restoration performance, and more particularly, to a car glass protection film having a self-restoration performance that prevents a separation phenomenon caused by temperature change, ultraviolet light, and external impact, exhibits excellent impact resistance by the urethane coating layer, and recovers from fine scratches using the self-restoration layer.

### BACKGROUND ART

In general, since a car is provided with glass attached to a front, a rear, and doors at both sides, and a vehicle body is formed of metal, the interior temperature of the car rise easily due to sunlight, and since the sunlight enters the interior of the car through the glass, the sunlight may tan the skin and interfere with driving.

In addition, since headlights recently have been are replaced with LED lights and emit strong light, a visual field for a driver may not be sufficiently ensured.

In particular, a film attached to a windshield of the car is required to solve the above problems and exhibit excellent visibility, however, the conventional car windshield film is composed of hard coated PET using a UV acrylic coating solution.

As for the above-described car windshield film composed of hard coated PET using a UV acrylic coating solution, the coating layer formed of the UV acrylic coating solution may be exfoliated from the PET layer or cracks and scratches may occur, when a wiper is operated in a state where physical properties are deteriorated due to a large temperature difference as in summer or winter, or due to ultraviolet rays, slight external impacts or the like.

In addition, since the film cannot be used continuously for a long time due to low durability even when the exfoliation, crack or scratch does not occur as above, the film is required to be replaced frequently. In addition, the exfoliation, crack or scratch in the coating layer may become a risk factor for safe driving, thereby interrupting the driver's view.

Accordingly, there is a need for a car glass protection film preventing a separation phenomenon caused by temperature change, ultraviolet light, and external impact, and having excellent impact resistance.

### DISCLOSURE

### Technical Problem

An object of the present invention is to provide a car glass protection film having a self-restoration performance that prevents a separation phenomenon caused by temperature change, ultraviolet light, and external impact, exhibits excellent impact resistance by the urethane coating layer, and recovers from fine scratches using the self-restoration layer.

### Technical Solution

According to a preferred embodiment of the present invention, the film includes: a substrate layer; a urethane coating layer formed on one surface of the substrate layer; a self-restoration layer formed on an upper surface of the urethane coating layer; a protection film layer formed on an upper surface of the self-restoration layer; and an adhesion layer formed on an opposite surface of the substrate layer, wherein the substrate layer is formed to have a thickness of 25 μm to 100 μm, and formed of corona or primer-treated polyethylene terephthalate, the urethane coating layer is formed of thermoplastic polyurethane having a thickness of 25 μm to 50 μm, and the self-restoration layer is formed to have a thickness of 10 μm to 40 μm, and formed of a urethane mixture.

According to another embodiment of the present invention, the urethane mixture may be composed of urethane resin, isocyanate, curing agent, and solvent.

According to still another embodiment of the present invention, the protection film layer may have a self-adhesive property, and formed of polypropylene or polyethylene.

According to still another embodiment of the present invention, the adhesion layer may be formed to have a thickness of 7 μm to 25 μm.

According to still another embodiment of the present invention, the adhesion layer may be composed of 100 parts by weight of acrylic copolymer, 2.5 to 3.5 parts by weight of curing agent, and 30 to 50 parts by weight of solvent.

Since the description of the technology disclosed in this specification is merely the embodiment for structural or functional description, the scope of the disclosed technology should not be construed as being limited by the embodiments described herein.

In other words, the embodiments may be variously modified and may have various forms, so it will be understood that the scope of the disclosed technology is intended to cover equivalents that can realize the technical idea. In addition, objects or effects presented in the disclosed technology do not mean that a specific embodiment include all of them or only the results, so the scope of the disclosed technology should not be construed as being limited thereby.

In addition, the meaning of the terms described in the present invention will be understood as follows. The terms such as “first” and “second” are used to distinguish one component from other components, and the scope of the claims are not be limited by these terms. For example, a first component may be designated as a second component, and similarly the second component may be designated as the first component.

Further, when one component is referred to as being “connected” to other component, the one component may be connected directly to the other component, but it will be understood that another component may exist therebetween. On the contrary, when one component is referred to as being “directly connected” to another component, it is understood that there are no other component therebetween. Meanwhile, other expressions describing the relationship between components, that is, “between”, “adjacent to” and “directly adjacent to” are required to be interpreted similarly.

The singular expression is construed as including a plural expression unless the context clearly specifies otherwise. It should be understood that the term such as “include” or “have” herein is intended to designate a presence of the incorporated feature, number, step, operation, element, component, or the combination thereof, and does not preclude the possibility of the presence or addition of one or more other features, numbers, steps, elements, components, or combinations thereof.

### Advantageous Effects

The car glass protection film having a self-restoration performance as described above can prevent a separation phenomenon caused by temperature change, ultraviolet light, and external impact, exhibit excellent impact resistance by the urethane coating layer, and recover from fine scratches using the self-restoration layer.

### DESCRIPTION OF DRAWINGS

FIG. 1 is an exploded perspective view showing a car glass protection film having a self-restoration performance according to one disclosed embodiment.

FIG. 2 shows photographs obtained by measuring self-restoration properties of a car glass protection film having a self-restoration performance manufactured according to Examples 1 and 2 of the present disclosure.

FIG. 3 shows photographs obtained by measuring water repellency of a car glass protection film having a self-restoration performance manufactured according to Example 2 of the present disclosure.

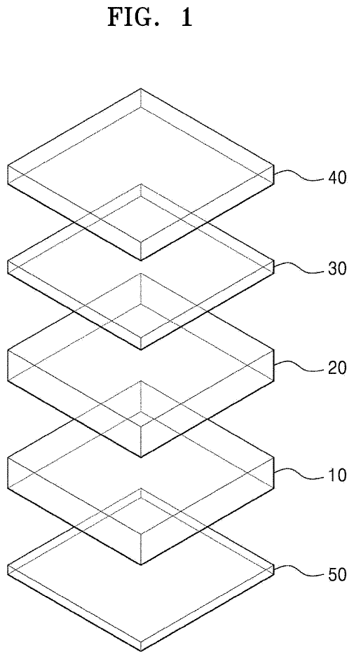

### BEST MODE

A car glass protection film having a self-restoration performance includes: a substrate layer; a urethane coating layer formed on one surface of the substrate layer; a self-restoration layer formed on an upper surface of the urethane coating layer; a protection film layer formed on an upper surface of the self-restoration layer; and an adhesion layer formed on an opposite surface of the substrate layer, wherein the substrate layer is formed to have a thickness of 25 μm to 100 μm, and formed of corona or primer-treated polyethylene terephthalate, the urethane coating layer is formed of thermoplastic polyurethane having a thickness of 25 μm to 50 μm, and the self-restoration layer is formed to have a thickness of 10 μm to 40 μm, and formed of a urethane mixture.

### MODE FOR INVENTION

Hereinafter, preferred embodiments of the present invention and physical properties of components will be described in detail. However, this is intended to describe in detail enough to enable a person having ordinary skill in the art to easily carry out the invention, and it should not be construed as signifying that the technical idea and scope of the present invention is limited thereby.

The disclosed car glass protection film having a self-restoration performance includes a substrate layer (10); a urethane coating layer (20) formed on one surface of the substrate layer (10); a self-restoration layer (30) formed on an upper surface of the urethane coating layer (20); a protection film layer (40) formed on an upper surface of the self-restoration layer (30); and an adhesion layer (50) formed on an opposite surface of the substrate layer (10).

The substrate layer 10 refers to a layer serving as base for the disclosed car glass protection film having the self-restoration performance, and formed of polyethylene terephthalate having a thickness of 25 to 100 μm to serving to improve shape stability of the disclosed car glass protection film having the self-restoration performance, thereby suppressing the deformation of the disclosed car glass protection film by an external force.

More preferably, the substrate layer 10 may be formed of corona or primer-treated polyethylene terephthalate. The corona or primer-treated substrate layer 10 in the above manner is improved in the bonding strength with the urethane coating layer 20 or the adhesion layer 50, so that the separation phenomenon may be improved.

When the substrate layer 10 has a thickness less than 25 μm, the above effect is insignificant, and when the substrate layer 10 has the thickness more than 100 μm, it is undesirable since the above effect is not significantly improved, the overall thickness and manufacturing cost of the car glass protection film are increased.

The urethane coating layer 20 is formed on one surface of the substrate layer 10 to have a thickness of 25 to 50 μm, and formed of thermoplastic polyurethane to serve to impart impact resistance to the disclosed car glass protection film having the improved self-restoration performance, thereby suppressing the deformation of the protection film from external impact.

It is more preferable that the urethane coating layer 20 is formed of hard type thermoplastic polyurethane. When the urethane coating layer 20 has the thickness less than 25 μm, the smoothness is improved, but the impact resistance is lowered. When the urethane coating layer 20 has the thickness more than 50 μm, the impact resistance of the car glass protection film is improved, but the smoothness is lowered, thereby failing to form the urethane coating layer 20 having a uniform thickness.

The self-restoration layer 30 is formed on the upper surface of the urethane coating layer 20 to have a thickness of 10 to 40 μm, and formed of a urethane mixture so as to serve to restore back to the original shape after the protection film is deformed due to fine scratches, external impacts, or press phenomenon.

The urethane mixture is composed of urethane resin, isocyanate, curing agent and solvent, and preferably may be composed of 100 parts by weight of urethane resin, 40 to 60 parts by weight of isocyanate, 60 to 90 parts by weight of curing agent, and 45 to 75 parts by weight of solvent.

The curing agent is not particularly limited and any curing agent can be used as long as it can cure a mixture composed of urethane resin and isocyanate. However, it is preferable to include one selected from the group consisting of benzophenone, ketone-based initiator, benzoic acid, anthraquinone and acylphosphine.

In addition, the solvent may be preferably formed of propylene glycol methyl ether acetate (PMA) or butyl acetate (BA).

When the self-restoration layer 30 has a thickness less than 10 μm, the restoring force against the fine scratches and the like is deteriorated. When the self-restoration layer 30 has the thickness more than 40 μm, the restoring force is not significantly improved, and the curing time is excessively increased in the process of forming the self-restoration layer 30, thereby deteriorating the production efficiency, and increasing the thickness of the car glass protection film.

The protection film layer 40 is formed on the upper surface of the self-restoration layer 30 to have a thickness of 25 to 50 μm, and formed of self-adhesive polypropylene or self-adhesive polyethylene to serve to protect the self-restoration layer 30.

When the protection film layer 40 has the thickness less than 25 μm, the protective effect on the self-restoration layer 30 is insignificant. When the protection film layer 40 has the thickness more than 50 μm, the protective effect on the self-restoration layer 30 is not significantly improved and the thickness of the car glass protection film is increased.

The adhesion layer 50 is formed on the other surface of the substrate layer 10 to have a thickness of 7 to 25 μm and formed of an acryl-based adhesive to serve to impart adhesive performance to the disclosed car glass protection film having the self-restoration performance, thereby allowing the car glass protection film to adhere to the car windshield.

Preferably, the acryl-based adhesive may be composed of 100 parts by weight of acrylic copolymer, 2.5 to 3.5 parts by weight of curing agent, and 30 to 50 parts by weight of solvent. The solvent may be preferably formed of one selected from the group consisting of methyl ethyl ketone, toluene and ethyl acetate.

When the adhesion layer 50 has a thickness less than 7 μm, it is difficult to exhibit the adhesive performance on a part in which flexion or unevenness of the car windshield occurs, and accordingly, the spacing or delamination phenomenon may occur. When the adhesion layer 50 has the thickness more than 25 μm, the adhesive performance on the part in which the flexion or unevenness of the car windshield occurs may not be significantly improved, a uniform thickness may not be formed due to low smoothness, and residues may be generated in the process of removing the car adhesion film from the windshield.

The car glass protection film having the self-restoration performance and having the above lamination structure may be manufactured through the following process: an adhesion layer 50 is formed by applying an acryl-based adhesive to a thickness of 7 to 25 μm on an upper surface of a silicone-coated release film by using a micro-gravure scheme; a substrate layer 10 formed of polyethylene terephthalate and having a thickness of 25 to 100 μm treated with corona or primer is laminated on an upper surface of the adhesion layer 50; a urethane coating layer 20 is formed by laminating thermoplastic polyurethane (Hard type) having a thickness of 25 to 50 μm on an upper surface of the substrate layer 10 by using a comma coating scheme; a self-restoration layer 30 is formed by coating a urethane mixture with a thickness of 10 to 40 μm on an upper surface of the urethane coating layer 20 by a micro gravure coating scheme; and a protection film layer 40 formed of self-adhesive polypropylene or self-adhesive polyethylene having a thickness of 25 to 35 μm is laminated on an upper surface of the self-restoration layer 30 to have a thickness of 25 to 50 μm.

Hereinafter, the manufacturing method of the disclosed car glass protection film having the self-restoration performance, and physical properties of the car glass protection film manufactured by the same will be described with examples.

### Example 1

A substrate layer is formed using corona-treated polyethylene terephthalate having a thickness of 100 μm; a urethane coating layer formed of thermoplastic polyurethane having a thickness of 25 μm is formed on one surface of the substrate layer; a self-restoration layer composed of 100 parts by weight of urethane mixture urethane resin having a thickness of 20 μm, 50 parts by weight of isocyanate, 75 parts by weight of curing agent (benzophenone) and 60 parts by weight of solvent is formed on an upper surface of the urethane coating layer; an acryl-based adhesive (100 parts by weight of acrylic copolymer, 3.0 parts by weight of curing agent, and 40 parts by weight of solvent) is applied to have a thickness of 15 μm on the other surface of the substrate layer; so that the car glass protection film having the self-restoration performance is manufactured.

### Example 2

It proceeds in the same manner as in Example 1 except that the substrate layer is formed to have a thickness of 50 μm, and the urethane coating layer is formed to have a thickness of 50 μm, so that the car glass protection film having the self-restoration performance is manufactured.

### Comparative Example 1

A substrate layer is formed using corona-treated polyethylene terephthalate having a thickness of 100 μm; a hard coating layer is formed on one surface of the substrate layer to have a thickness of 3 μm; and an acryl-based adhesive (100 parts by weight of acrylic copolymer, 3.0 parts by weight of curing agent, and 40 parts by weight of solvent) is applied to have a thickness of 15 μm on the other surface of the substrate layer; so that so that the car glass protection film is manufactured.

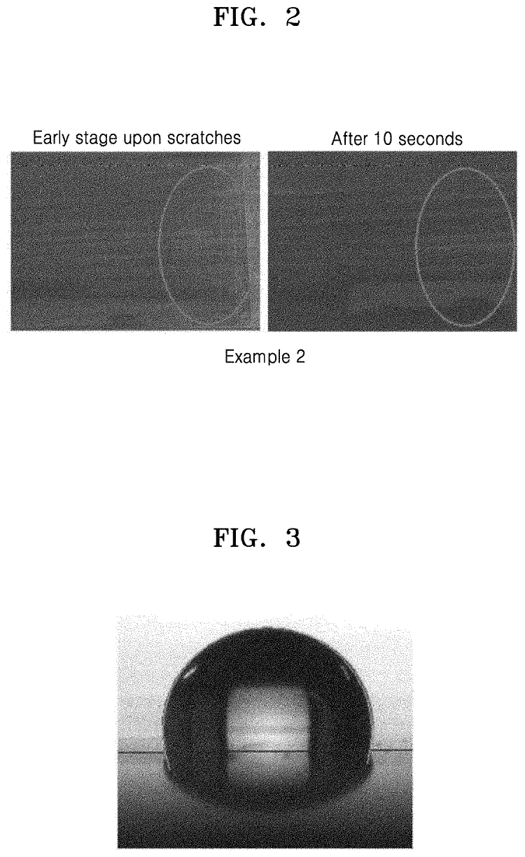

the self-restoration properties of the car glass protection film having the self-restoration performance manufactured according to Examples 1 and 2 is measured and shown in Table 1 and FIG. 2 below.

TABLE 1

| | Restored |
|---|---|
| Item | time |
| Example 1 | 12 |
| Example 2 | 10 |

As shown in Table 1 above and FIG. 2 below, it can be seen that the car glass protection film manufactured according to Examples 1 and 2 of the present invention exhibits excellent self-restoration properties.

In particular, it can be seen the case of Example 2, in which the urethane coating layer is formed thickly shows that the protection film has the faster self-restoration speed.

In addition, the adhesive force according to aging of the car glass protection film manufactured according to Examples 1 and 2 and Comparative Example 1 is measured and shown in Table 2 below.

TABLE 2

| | Adhesive force by aging | | |
|---|---|---|---|
| | 30 | 24 | |
| Item | Minutes | Hours | 1 week |
| Example 1 | 672 | 1300 | 1611 |
| Example 2 | 626 | 1055 | 1520 |
| Example 3 | 687 | 1172 | 1541 |

As shown in Table 2 above, it can be seen that the car glass protection film manufactured according to Examples 1 and 2 of the present invention exhibits adhesive force comparable to that of the conventional car glass protection film manufactured according to Comparative Example 1.

In addition, the water repellency of the car glass protection film having the self-restoration performance manufactured according to Example 1 is measured and shown in Table 3 and FIG. 3 below

(wherein, the water repellency is measured by using a scheme of measuring a contact angle between the protection film and water after the water is sprayed on the surface of the protection film manufactured according to Example 2).

TABLE 3

| | Contact |
|---|---|
| Item | angle (°) |
| Example 2 | 100 |

As shown in Table 3 above and FIG. 3 below, it can be seen that the car glass protection film having the self-restoration performance manufactured according to Example 2 of the present invention has the excellent water repellency.

Accordingly, it is provided with the disclosed car glass protection film having a self-restoration performance that can prevent a separation phenomenon caused by temperature change, ultraviolet light, and external impact, exhibit excellent impact resistance by the urethane coating layer, and recover from fine scratches using the self-restoration layer

(wherein, the self-restoration is measured by using a time taken until that scratches are restored and cannot be recognized with naked eyes after the surface of the protection film is rubbed with steel wool for 3 seconds to generate the scratches).

Although the present invention has been described with reference to exemplary embodiments, it will be apparent to a person having ordinary skill in the art that various modifications and variations can be made in the present invention without departing from the scope and field of the following appended claims.

### INDUSTRIAL APPLICABILITY

The present invention is not limited to the above-described specific preferred embodiments, and it will be apparent to those having ordinary skills in the art in that various modifications are construed to be available within the scope of the claims without departing from the invention, and fall within the scope of the claims as far as technical ideas form such modifications.

1. A car glass protection film having a self-restoration performance, the car glass protection film comprising:
a substrate layer;
a urethane coating layer formed on one surface of the substrate layer;
a self-restoration layer formed on an upper surface of the urethane coating layer;
a protection film layer formed on an upper surface of the self-restoration layer; and
an adhesion layer formed on an opposite surface of the substrate layer, wherein the substrate layer is formed to have a thickness of 25 μm to 100 μm, and formed of corona or primer-treated polyethylene terephthalate,
the urethane coating layer is formed of thermoplastic polyurethane having a thickness of 25 μm to 50 μm, and the self-restoration layer is formed to have a thickness of 10 μm to 40 μm, and formed of a urethane mixture.

2. The car glass protection film of claim 1, wherein the urethane mixture is composed of urethane resin, isocyanate, curing agent, and solvent.

3. The car glass protection film of claim 1, wherein the protection film layer has a self-adhesive property, and includes polypropylene or polyethylene.

4. The car glass protection film of claim 1, wherein the adhesion layer is configured to have a thickness of 7 μm to 25 μm.

5. The car glass protection film of claim 1, wherein the adhesion layer includes 100 parts by weight of acrylic copolymer, 2.5 to 3.5 parts by weight of hardener, and 30 to 50 parts by weight of solvent.

6. The car glass protection film of claim 4, wherein the adhesion layer includes 100 parts by weight of acrylic copolymer, 2.5 to 3.5 parts by weight of hardener, and 30 to 50 parts by weight of solvent.
